(19) United States
(12) Patent Application Publication
(10) Pub. No.: US 2011/0300906 A1
(43) Pub. Date: Dec. 8, 2011

(54) Multi-Function Cell Phone Charger Apparatus

(76) Inventor: Joseph G. Colgan, Islamorada, FL (US)

(21) Appl. No.: 12/792,312

(22) Filed: Jun. 2, 2010

(51) Int. Cl. H04W 52/00

(52) U.S. Cl. 455/558; 455/573

(57) ABSTRACT

The multi-function cell phone charger apparatus provides convenience and security for a cell phone and cell phones that was not previously provided, in that cell phone information is automatically backed up when the cell phone is linked with the apparatus for charging. The apparatus may provide backup partially through the removably contained SIM (subscription identity module) and the removably contained media card. Importantly, the removability of the SIM and media card from the apparatus allow for a user to transfer the cards from a first phone to another phone and thereby have identical phone functions and stored information within any given phone. Further, there is no limit to the number of SIM and media cards that can be used and therefore no limit to the number of cell phones or other electronic devices with which the information stored on cards can be shared.

### BACKGROUND OF THE INVENTION

Cell phones have become integral to the lives of countless millions. Along with that integration have come continual improvements and additional cell phone capabilities. Cell phone cameras are ubiquitous. Internet surfing, texting, and a variety of other actions are now cell phone habits. With the added functionality, the information held within cell phones continually becomes more important to the phone users. Cell phones have SIM's and media cards on which information is stored. Loss of that information is always a possibility. The present apparatus provides for cell phone charging and, at the same time, automatic backup of all information held within a cell phone.

### FIELD OF THE INVENTION

The multi-function cell phone charger apparatus relates to cell phone charger apparatus and more especially to a multi-function cell phone charger apparatus that also provides an SIM, a media card, and therein automatic backup of information held within a cell phone.

### SUMMARY OF THE INVENTION

The general purpose of the multi-function cell phone charger apparatus, described subsequently in greater detail, is to provide a multi-function cell phone charger apparatus which has many novel features that result in an improved multi-function cell phone charger apparatus which is not anticipated, rendered obvious, suggested, or even implied by prior art, either alone or in combination thereof.

To attain this, the multi-function cell phone charger apparatus provides convenience and security for a cell phone and cell phones that was not previously provided, in that cell phone information is automatically backed up when the cell phone is linked with the apparatus for charging. The apparatus may provide backup partially through the removably contained SIM (subscription identity module) and the media card. Importantly, the removability of the SIM and media card from the apparatus allow for a user to transfer the cards from a first phone to another phone and thereby have identical phone functions and stored information within any given phone.

Further, there is no limit to the number of SIM and media cards that can be used and therefore no limit to the number of cell phones or other electronic devices with which the information stored on cards can be shared. A more basic form of the apparatus may use internally housed memory, without the use of cards.

Upon connection to a cell phone or other similar personal electronic device, and a power source, the apparatus automatically charges the cell phone and at the same time backs up any information carried by the cell phone and any cards it may use.

Thus has been broadly outlined the more important features of the improved multi-function cell phone charger apparatus so that the detailed description thereof that follows may be better understood and in order that the present contribution to the art may be better appreciated.

An object of the multi-function cell phone charger apparatus is to charge a cell phone.

Another object of the multi-function cell phone charger apparatus is to back up cell phone media card data.

A further object of the multi-function cell phone charger apparatus is to back up cell phone SIM data.

An added object of the multi-function cell phone charger apparatus is to operate automatically upon cell phone plug in.

And, an object of the multi-function cell phone charger apparatus is to shield the card slots and cards disposed within the apparatus housing from invasion by unwanted materials.

These together with additional objects, features and advantages of the improved multi-function cell phone charger apparatus will be readily apparent to those of ordinary skill in the art upon reading the following detailed description of presently preferred, but nonetheless illustrative, embodiments of the improved multi-function cell phone charger apparatus when taken in conjunction with the accompanying drawings.

In this respect, before explaining the current embodiments of the improved multi-function cell phone charger apparatus in detail, it is to be understood that the multi-function cell phone charger apparatus is not limited in its application to the details of construction and arrangements of the components set forth in the following description or illustration. Those skilled in the art will appreciate that the concept of this disclosure may be readily utilized as a basis for the design of other structures, methods, and systems for carrying out the several purposes of the improved multi-function cell phone charger apparatus. It is therefore important that the claims be regarded as including such equivalent constructions insofar as they do not depart from the spirit and scope of the multi-function cell phone charger apparatus. It is also to be understood that the phraseology and terminology employed herein are for purposes of description and should not be regarded as limiting.

### BRIEF DESCRIPTION OF THE DRAWINGS

FIG. 1 is a front perspective view.

FIG. 2 is a front perspective view, removable cover removed.

FIG. 3 is a side elevation view.

FIG. 4 is a bottom side elevation view.

FIG. 5 is a schematic block diagram of electronic components of the apparatus.

### DETAILED DESCRIPTION OF THE DRAWINGS

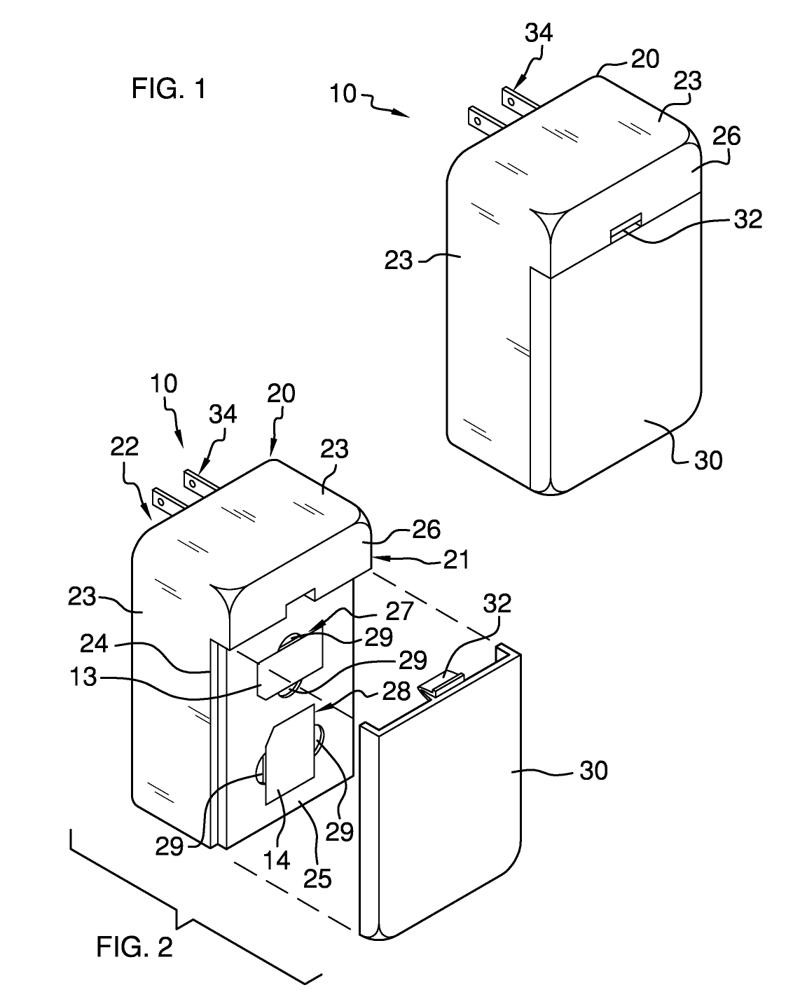

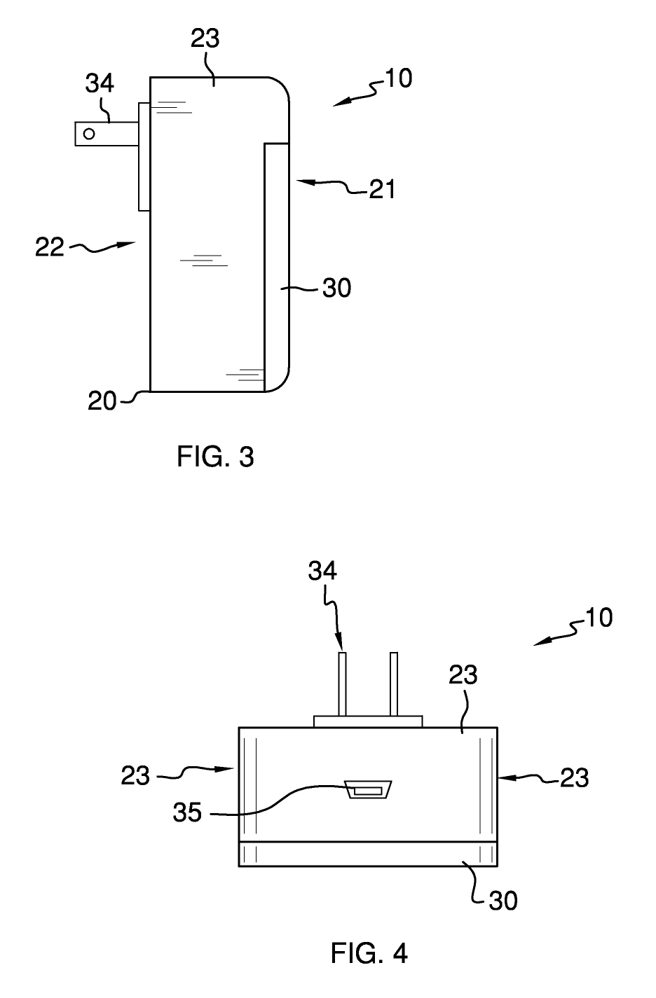

With reference now to the drawings, and in particular FIGS. 1 through 5 thereof, the principles and concepts of the multi-function cell phone charger apparatus generally designated by the reference number 10 will be described.

Referring to FIGS. 1 and 4, the apparatus 10 partially comprises the parallelepiped housing 20 having a front 21 spaced apart from a back 22, and a quartet of spaced apart sides 23.

Referring to FIG. 2, the housing 20 further comprises the stepped recession 24 disposed within the front 21. The shelf 25 is disposed within the stepped recession 24. The overhang 26 of the housing 20 is disposed above the stepped recession 24. The removable cover 30 is disposed over the stepped recession 24 and fitted exteriorly to the shelf 25 and under the overhang 26. With cover 30 fitted, the housing 20 is flush on front 21, back 22, and all sides 23. The retention clip 32 is disposed on the cover 30. The retention clip 32 removably engages the housing 20 so that the cover 30 is selectively retained on the housing 20. By providing the stepped recession 24, with elevated shelf 25, along with the overhang 26, the apparatus 10 protects itself and contained cards and ports against unwanted invasion of dirt, moisture, and other unwanted foreign materials.

Continuing to refer to FIG. 2, the front facing SIM port 27 is disposed within the shelf 25. A pair of spaced apart grip indentions 29 is disposed laterally in the SIM port so that SIM's 13 can more easily be added and removed. The media port 28 is disposed within the shelf 25. A pair of spaced apart grip indentions 29 is disposed laterally in the media port 28 so that media cards 14 are more easily added and removed.

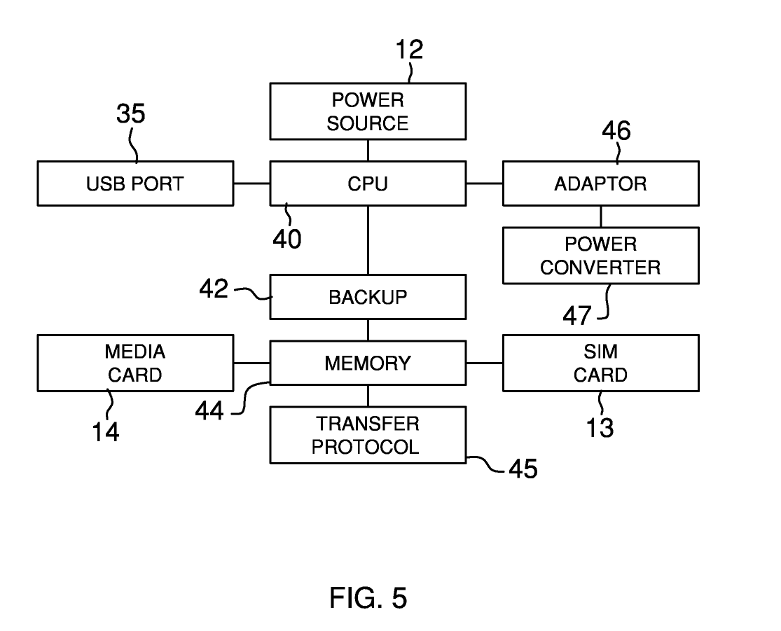

Referring to FIG. 5, the CPU 40 is disposed within the housing 20. The CPU 40 is in communication with the SIM port 27 and the media port 28. The power access 34 on the housing 20 is in communication with the CPU 40. The power access 34 may be a plug, as illustrated, or may be any other form of accepted power access 34. An adapter 46 is disposed within the housing 20 and is in communication with the CPU 40 and the power access 34. The power converter 47 is disposed within the housing 20 and is in communication with the CPU 40 and the power access 34. The backup 42 is disposed within the housing 20. The backup 42 is in communication with the CPU 40. The backup 42 further comprises a memory 44. The memory 44 is comprised of an existing media card 14 removably disposed within the media port 28. Media cards 14 are widely known and available in the art. An existing SIM 13 is removably disposed within the SIM port 27. The transfer protocol 45 is a part of the memory 44. Upon insertion of a USB cable end into the USB port disposed in one of the housing 20 sides 23, the information contained within a cell phone's memory, SIM 13, and media card 14 is automatically retrieved by the cards removably held within the apparatus 10. At the same time, the cell phone battery is charged.

The processor 40 may include a microprocessor or other devices capable of being programmed or configured to perform computations and instruction processing in accordance with the invention. Such other devices may include microcontrollers, digital signal processors (DSP), Complex Programmable Logic Device (CPLD), Field Programmable Gate Arrays (FPGA), application-specific integrated circuits (ASIC), discrete gate logic, and/or other integrated circuits, hardware or firmware in lieu of or in addition to a microprocessor.

Functions and process steps described herein may be performed using programmed computer devices and related hardware, peripherals, equipment and networks. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

The memory 44 includes programmable software instructions that are executed by the CPU 40. In particular, the programmable software instructions include a plurality of chronological operating steps that define a control logic algorithm for performing the intended functions of the present invention. Such software instructions may be written in a variety of computer program languages such as C++, Fortran and Pascal, for example. One skilled in the art understands that such software instructions may contain various Boolean logic processes that perform the intended function of the present invention. Therefore, the specific source or object code of the software program is not intended to be a limiting factor in executing the present invention's intended function.

The memory 44, which enables storage of data and programs, may include RAM, ROM, flash memory and any other form of readable and writable storage medium known in the art or hereafter developed. The memory 44 may be a separate component or an integral part of another component such as any other processor.

The power source may include one or more rechargeable or non-rechargeable disposable batteries, photovoltaic cells, and/or an AC adapter or plug 34 or other power supply means.

The combination of such claimed elements provides an unpredictable and unexpected result that is not rendered obvious by one skilled in the art. The removability of the SIM and media card allow for a user to transfer the cards to from a first phone to another phone and thereby have identical phone functions and stored information within any given phone, relative to the first phone. The card removability also allows for the cards to be plugged into other devices, such as computers, and the information stored thereon further shared and backed up.

With respect to the above description then, it is to be realized that the optimum dimensional relationships for the parts of the multi-function cell phone charger apparatus, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the multi-function cell phone charger apparatus.

Directional terms such as “front”, “back”, “in”, “out”, “downward”, “upper”, “lower”, and the like may have been used in the description. These terms are applicable to the embodiments shown and described in conjunction with the drawings. These terms are merely used for the purpose of description in connection with the drawings and do not necessarily apply to the position in which the multi-function cell phone charger apparatus may be used.

Therefore, the foregoing is considered as illustrative only of the principles of the multi-function cell phone charger apparatus. Further, since numerous modifications and changes will readily occur to those skilled in the art, it is not desired to limit the multi-function cell phone charger apparatus to the exact construction and operation shown and described, and accordingly, all suitable modifications and equivalents may be resorted to, falling within the scope of the multi-function cell phone charger apparatus.

What is claimed is:

1. A multi-function phone charger apparatus comprising, in combination:
a parallelepiped housing having a front spaced apart from a back, a quartet of spaced apart sides;
a CPU disposed within the housing;
a power access on the housing, the power access in communication with the CPU, the power access selectively in communication with an external power source;
an adapter disposed within the housing, the adapter in communication with the CPU;
a power converter disposed within the housing, the power converter in communication with the CPU and the power access;
a backup disposed within the housing, the backup in communication with the CPU;
whereby the apparatus' connection to an existing cell phone provides automatic charging of the cell phone and backup of any cell phone stored data.

2. A multi-function phone charger apparatus comprising, in combination:
a parallelepiped housing having a front spaced apart from a back, a quartet of spaced apart sides;
a stepped recession disposed within the front;
a shelf disposed within the stepped recession;
an overhang of the housing disposed above the stepped recession;
a removable cover disposed over the stepped recession and fitted exteriorly to the shelf and under the overhang;
a retention clip disposed on the cover, the retention clip removably engaging the housing;
an SIM port disposed frontally within the shelf;
a pair of spaced apart grip indentions disposed laterally in the SIM port;
a media port disposed frontally within the shelf;
a pair of spaced apart grip indentions disposed laterally in the media port;
a CPU disposed within the housing, the CPU in communication with the SIM port and the media port;
a power access on the housing, the power access in communication with the CPU;
an adapter disposed within the housing, the adapter in communication with the CPU;
a power converter disposed within the housing, the power converter in communication with the CPU and the power access;
a backup disposed within the housing, the backup in communication with the CPU, the backup further comprising:
a memory, the memory further comprising:
a media card removably disposed within the media port;
a SIM removably disposed within the SIM port;
a transfer protocol;
whereby the apparatus' connection to an existing cell phone provides automatic charging of the cell phone and backup of any cell phone stored data.
